(19) United States
(12) Patent Application Publication
(10) Pub. No.: US 2017/0022950 A1
(43) Pub. Date: Jan. 26, 2017

(54) FLUID INJECTOR

(71) Applicant: GM GLOBAL TECHNOLOGY OPERATIONS LLC, Detroit, MI (US)

(72) Inventor: William D. Gough, Metamora, MI (US)

(73) Assignee: GM GLOBAL TECHNOLOGY OPERATIONS LLC, Detroit, MI (US)

(21) Appl. No.: 14/808,504

(22) Filed: Jul. 24, 2015

(51) Int. Cl. F02M 51/06; F02M 61/18

(52) U.S. Cl. CPC F02M 51/06; F02M 61/186

(57) ABSTRACT

A fuel injector includes an injector tip defining a plurality of injection apertures. A first control device is coupled to the injector tip, and is operable to control fluid flow through at least a first one of the plurality of injection apertures. A second control device is coupled to the injector tip, and is operable to control fluid flow through at least a second one of the plurality of injection apertures. The first control device and the second control device each include a MEMS or a NEMS flow controller for controlling fluid flow through a respective injection aperture, and are independently operable relative to each other to provide variable fluid flow rates and/or injection spray patterns.

### TECHNICAL FIELD

The disclosure generally relates to a fluid injector, and more specifically to a liquid fuel injector for an internal combustion engine.

### BACKGROUND

Fluid injectors, such as liquid fuel injectors are used to inject fuel, such as for example, into a combustion chamber of a cylinder of an engine. The fuel may be injected into the combustion chamber for in-cylinder combustion for generating motive power, or may be injected into the combustion chamber after in-cylinder combustion for performing various different operations of an exhaust gas treatment system. Fuel injectors may alternatively be installed in the exhaust gas treatment system to directly inject fuel into a flow of exhaust gas.

The optimum injection rate and/or optimum injection spray pattern for each function may differ. For example, the optimum fuel injection rate and/or injection spray pattern for in-cylinder combustion when the vehicle is operating in cold weather at high power output may differ from the optimum fuel injection rate and/or injection spray pattern for in-cylinder combustion when the vehicle is operating in hot weather at low power output. Additionally, the optimum fuel injection rate and/or injection spray pattern for in-cylinder combustion may differ from the optimum fuel injection rate and/or injection spray pattern for in-cylinder post combustion injection for exhaust gas treatment operations. Controlling the fuel injectors to operate at their optimum levels for the current function being performed improves the operating efficiency of the engine.

### SUMMARY

A fluid injector is provided. The fluid injector includes an injector tip defining a plurality of injection apertures. A first control device is coupled to the injector tip, and is operable to control fluid flow through at least a first one of the plurality of injection apertures. A second control device is coupled to the injector tip, and is operable to control fluid flow through at least a second one of the plurality of injection apertures. The first control device and the second control device are independently operable relative to each other, such that one of the first one of the plurality of injection apertures and the second one of the plurality of injection apertures may be opened to allow fluid flow therethrough, while the other of the first one of the plurality of injection apertures and the second one of the plurality of injection apertures may be simultaneously closed to prevent fluid flow therethrough.

A fuel injector for a vehicle having an internal combustion engine is also provided. The fuel injector includes an injector tip defining a first group of injection apertures and a second group of injection apertures. A first control device is coupled to the injector tip, and is operable to control fluid flow through the first group of injection apertures. A second control device is coupled to the injector tip, and is operable to control fluid flow through the second group of injection apertures. Each of the first control device and the second control device includes one of either a Micro-Electrical-Mechanical System (MEMS) flow controller, or a Nano-Electrical-Mechanical System (NEMS) flow controller. The first control device and the second control device are independently operable relative to each other to selectively control fluid flow through each of the first group of injection apertures and the second group of injection apertures, such that one of the first group of injection apertures and the second group of injection apertures may be opened to allow fluid flow therethrough, while the other of the first group of injection apertures and the second group of injection apertures may be closed to prevent fluid flow therethrough.

Accordingly, the fluid injector may be configured and/or controlled to provide a range of different fluid injection rates, and a plurality of different fluid injection patterns, in order to provide an optimum operating condition for several different functions and/or conditions. When used to inject a liquid fuel into an internal combustion engine, the variable flow and/or injection pattern provided by the fluid injector improves the operating efficiency of the engine.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic cross sectional view of a fluid injector.

FIG. 2 is a schematic plan view of an injector tip of the fluid injector showing a first operating condition.

FIG. 3 is a schematic plan view of the injector tip showing a second operating condition.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a fluid injector is generally shown at 20. The fluid injector 20 is operable to inject a pressurized fluid into a chamber, container, vessel, etc. The fluid may include any fluid, such as but not limited to water, gas, diesel, chemical compounds, etc. For example, an exemplary embodiment of the fluid injector 20 may be configured as a liquid fuel injector for an internal combustion engine of a vehicle, such as an automobile, ATV, snowmobile, tractor, train, airplane, etc. However, it should be appreciated that the fluid injector 20 may be configured for applications other than vehicular applications, and may be configured for fluids other than a fuel.

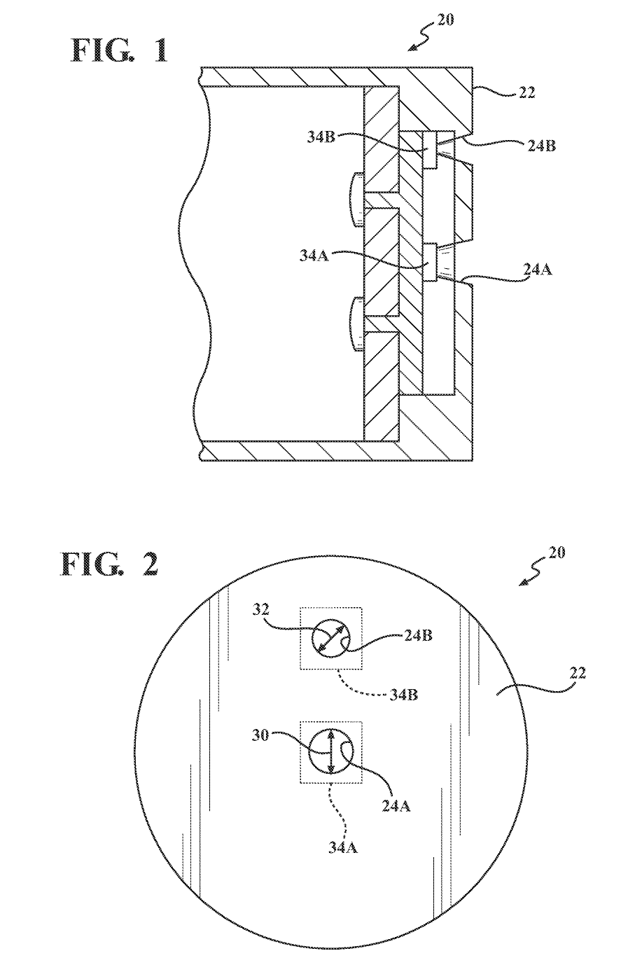

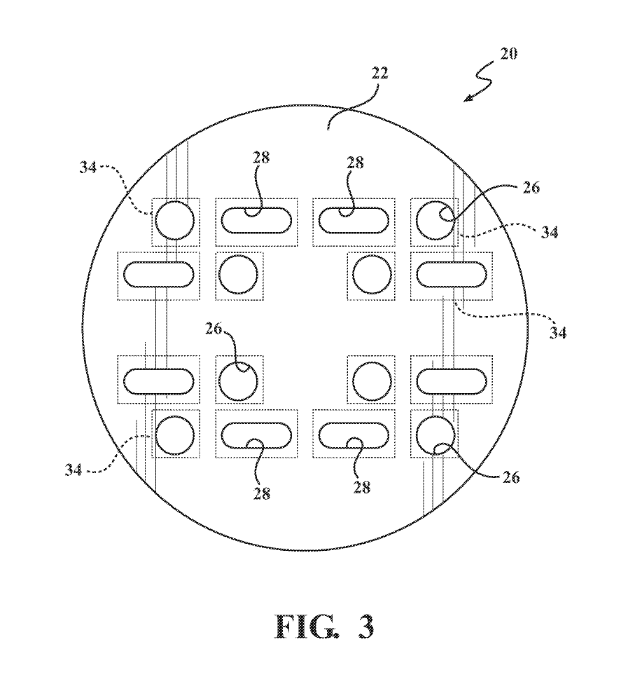

Referring to FIG. 1, the fluid injector 20 includes an injector tip 22 that defines a plurality of injection apertures 24. The injector tip 22 is a generally planar or plate like structure, that defines the injection apertures 24, through which the fluid is injected. Referring to FIG. 2, the plurality of injection apertures 24 includes at least a first one of the plurality of injection apertures 24, hereinafter referred to as the first injection aperture 24A, and a second one of the plurality of injection apertures 24, hereinafter referred to as the second injection aperture 24B. The injection apertures 24, including the first injection aperture 24A and the second injection aperture 24B, are referred to generally by the reference numeral 24. The first injection aperture 24A and the second injection aperture 24B are referred to specifically by their respective reference numerals 24A, and 24B respectively. It should be appreciated that the injector tip 22 may define more injection apertures 24 than just the first injection aperture 24A and the second injection aperture 24B shown in FIG. 2. For example, referring to FIG. 3, the plurality of injection apertures 24 may include a first group 26 of injection apertures 24, which may include the first injection aperture 24A, and a second group 28 of injection apertures 24, which may include the second injection aperture 24B. As shown in FIG. 3, the injection apertures 24 of the first group 26 of injection apertures 24 are each configured to define a circular shape, whereas the injection apertures 24 of the second group 28 of injection apertures 24 are each configured to define an oval shape. It should be appreciated that the injection apertures 24 may include more than the exemplary first group 26 and second group 28 of injection apertures 24, and may include any number of groups of injection apertures 24.

Each of the injection apertures 24 may be sized and shaped in an identical configuration. Alternatively, each of the plurality of injection apertures 24 may include a different size and/or shape. Furthermore, each injection aperture 24 of respective groups may include the same size and/or shape as all other injection apertures 24 of that respective group, or may include a different size and/or shape relative to all of the other injection apertures 24 of that respective group.

Referring to FIG. 2, a simplified embodiment of the injector tip 22 is shown as an exemplary embodiment. The injector tip 22 shown in FIG. 2 includes the first injection aperture 24A, and the second injection aperture 24B. The first injection aperture 24A defines a first injection area capable of injecting fluid at a first injection rate. The second injection aperture 24B defines a second injection area capable of injecting fluid at a second injection rate. The second injection area is different than the first injection area, so that the second injection rate is different than the first injection rate. As shown in FIG. 2, the first injection aperture 24A is generally configured to define a circular shape having a first diameter 30, and the second injection aperture 24B is generally configured to define a circular shape having a second diameter 32. The first diameter 30 is larger than the second diameter 32. As such, the first injection area is larger than the second injection area, and the first injection rate is thereby higher than the second injection rate. It should be appreciated that the first injection aperture 24A and the second injection aperture 24B may be configured to define a shape other than the exemplary circular shape shown in FIG. 2, such as oval, square, hexagonal, etc.

Referring to FIG. 3, an alternative embodiment of the injector tip 22 is shown as another exemplary embodiment. The injector tip 22 shown in FIG. 3 includes the first group 26 of injection apertures 24, and the second group 28 of injection apertures 24. The first group 26 of injection apertures 24 is arranged to define a first aperture arrangement that is operable to inject fluid in a first spray pattern. As shown in FIG. 3, the injection apertures 24 of the first group 26 of injection apertures 24 are each configured to define a circular flow area, and are arranged in a substantially X-shaped configuration. The second group 28 of injection apertures 24 is arranged to define a second aperture arrangement that is operable to inject fluid in a second spray pattern. As shown in FIG. 3, the injection apertures 24 of the second group 28 are each configured to define a generally oval flow area, and are arranged in a substantially rectangular shaped configuration. The second spray pattern is different than the first spray pattern. It should be appreciated that the specific patterns that the different groups of injection apertures 24 may be configured to define may differ from the patterns shown in FIG. 3. Additionally, if the plurality of injection apertures 24 includes more than the exemplary two groups of injection apertures 24, then each of the multiple groups of injection apertures 24 may be arranged to define a respective configuration to achieve a respective injection spray pattern.

The fluid injector 20 includes a plurality of control devices, e.g., valves. Specifically, the fluid injector 20 includes at least a first control device 34A and a second control device 34B. The control devices, including the first control device 34A and the second control device 34B, are referred to generally herein with the reference numeral 34. The first control device 34A and the second control device 34B are referred to specifically by the reference numerals 34A, and 34B respectively. The first control device 34A and the second control device 34B are each coupled to the injector tip 22, and are each operable to control fluid flow through at least one respective injection aperture 24. Referring to FIG. 1, the first control device 34A is shown coupled to the injector tip 22, and is operable to control fluid flow through at least the first injection aperture 24A. The first control device 34A is attached to the injector tip 22 adjacent to the first injection aperture 24A. The second control device 34B is coupled to the injector tip 22, and is operable to control fluid flow through at least the second injection aperture 24B. The second control device 34B is attached to the injector tip 22 adjacent the second injection aperture 24B.

If the plurality of injection apertures 24 includes more than just the first injection aperture 24A and the second injection aperture 24B shown in FIGS. 1 and 2, such as the first group 26 of injection apertures 24 and the second group 28 of injection apertures 24 shown in FIG. 3, then the first control device 34A and the second control device 34B may each control fluid flow through multiple injection apertures 24. For example, the first control device 34A may control fluid flow through all of the injection apertures 24 of the first group 26 of injection apertures 24, and the second control device 34B may control fluid flow through all of the injection apertures 24 of the second group 28 of injection apertures 24. Alternatively, such as shown in FIG. 3, each of the plurality of injection apertures 24 may include a respective control device 34 for controlling fluid flow through its respective injection aperture 24, with each control device 34 being attached to the injector tip 22 adjacent its respective injection aperture 24. As shown in FIG. 3, the control device 34 for each respective injection aperture 24 is shown in phantom as a square surrounding its respective injection aperture 24. If each of the plurality of injection apertures 24 is equipped with a respective control device 34, then each of the plurality of injection apertures 24 may be controlled independently of all of the other of the plurality of injection apertures 24. Alternatively, each of the control valves associated with the injection apertures 24 of the first group 26 of injection apertures 24 may be controlled in the same manner, whereas each of the control valves associated with the injection apertures 24 of the second group 28 of injection apertures 24 may be controlled in the same manner.

Each control device 34, for example the first control device 34A and the second control device 34B shown in FIG. 1, or each control device 34 of each respective injection aperture 24 shown in FIG. 3, includes one of either a Micro-Electrical-Mechanical System (MEMS) flow controller or a Nano-Electrical-Mechanical System (NEMS) flow controller. The MEMS flow controller and/or the NEMS flow controller are devices that are capable of opening and closing fluid flow through a respective one of the injection apertures 24. The MEMS flow controller and/or the NEMS flow controller may be configured in any suitable manner, and are characterized by the use of a MEMS device and/or a NEMS device respectively to actuate the control devices 34 respectively.

Generally, a MEMS device, such as a MEMS fluid controller, may be considered to include a class of systems that are physically small, having features with sizes in the micrometer range. The critical physical dimensions of MEMS devices can vary from well below one micron on the lower end of the dimensional spectrum, all the way to several millimeters. MEMS devices may have both electrical and mechanical components. The types of MEMS devices can vary from relatively simple structures having no moving elements, to extremely complex electromechanical systems with multiple moving elements under the control of integrated microelectronics. The one main criterion of a MEMS device is that there are at least some elements having some sort of mechanical functionality whether or not these elements can move. MEMS devices are produced through micromachining processes. The term “micromachining” generally refers to the production of three-dimensional structures and moving parts through processes including modified integrated circuit (computer chip) fabrication techniques (such as chemical etching) and materials (such as silicon semiconductor material).

Nano-Electrical-Mechanical Systems (NEMS) are a class of devices integrating electrical and mechanical functionality on the nanoscale. NEMS devices form the logical next miniaturization step from the MEMS based devices. NEMS devices typically integrate transistor-like nanoelectronics with mechanical actuators, pumps, or motors. The name derives from typical device dimensions in the nanometer range.

NEMS devices may be manufactured from a top-down approach using traditional microfabrication methods, i.e. optical and electron beam lithography. Typically, NEMS devices are fabricated from metallic thin films or etched semiconductor layers. Alternatively, NEMS devices may be manufactured from a bottom-up approach, using the chemical properties of single molecules to cause single-molecule components to (a) self-organize or self-assemble into some useful conformation, or (b) rely on positional assembly. These approaches utilize the concepts of molecular self-assembly and/or molecular recognition. A combination of these approaches may also be used, in which nanoscale molecules are integrated into a top-down framework.

The MEMS based devices and/or the NEMS based devices may be actuated to produce mechanical movement in any suitable manner, including but not limited to thermal actuation, electrostatic actuation, magnetic actuation, piezoelectric actuation or electrical actuation. Furthermore, the MEMS based devices and/or the NEMS based devices may include a shape memory alloy element for effecting mechanical movement within the respective device. Each control device 34 may be responsive to a respective control signal that is dedicated to only that respective control device 34, such that all respective control signals for all of the control devices 34 may be separate and independent from each other, thereby allowing dedicated control of each individual control device 34.

The fluid injector 20 may be controlled to provide variable fluid injection rates and/or variable fluid injection spray patterns. As described above, the first injection aperture 24A defines a fluid injection rate that is greater than the fluid injection rate of the second injection aperture 24B. Referring to FIG. 2, the first control device 34A and the second control device 34B are independently operable relative to each other, such that one of the first injection aperture 24A and the second injection aperture 24B may be opened to allow fluid flow therethrough, while the other of the first injection aperture 24A and the second injection aperture 24B may be simultaneously closed to prevent fluid flow therethrough. For example, the first control device 34A may be controlled to allow fluid flow through the first injection aperture 24A, and the second control device 34B may be simultaneously controlled to prevent fluid flow through the second injection aperture 24B, such that fluid may be injected through only the first injection aperture 24A at the first injection rate. Alternatively, the first control device 34A may be controlled to prevent fluid flow through the first injection aperture 24A, and the second control device 34B may be simultaneously controlled to allow fluid flow through the second injection aperture 24B, such that fluid may be injected through only the second injection aperture 24B at the second injection rate. In yet another possibility, the first control device 34A may be controlled to allow fluid flow through the first injection aperture 24A, and the second control device 34B may be simultaneously controlled to allow fluid flow through the second injection aperture 24B, such that fluid may be injected through both the first injection aperture 24A and the second injection aperture 24B at a third injection rate, which is approximately equal to the sum of the first injection rate and the second injection rate.

Referring to the exemplary embodiment of the injector tip 22 shown in FIG. 3, the same principle may be applied. Realizing that, due to the shape, size and number of the injection apertures 24 within each different group of injection apertures 24, the first group 26 of injection apertures 24 will inject fluid at a first injection rate, and the second group 28 of injection apertures 24 will inject fluid at a second injection rate. Accordingly, the first group 26 of injection apertures 24 may be controlled by their respective control devices 34 to allow fluid flow through each of the first group 26 of injection apertures 24, and the second group 28 of injection apertures 24 may be simultaneously controlled by their respective control devices 34 to prevent fluid flow through each of the second group 28 of injection apertures 24, such that fluid may be injected through only the first group 26 of injection apertures 24 at the first injection rate. Alternatively, the first group 26 of injection apertures 24 may be controlled by their respective control devices 34 to prevent fluid flow through each of the first group 26 of injection apertures 24, and the second group 28 of injection apertures 24 may be simultaneously controlled by their respective control devices 34 to allow fluid flow through each of the second group 28 of injection apertures 24, such that fluid may be injected through only the second group 28 of injection apertures 24 at the second injection rate. In yet another possibility, the first group 26 of injection apertures 24 may be controlled by their respective control devices 34 to allow fluid flow through each of the first group 26 of injection apertures 24, and the second group 28 of injection apertures 24 may be simultaneously controlled by their respective control devices 34 to also allow fluid flow through each of the second group 28 of injection apertures 24, such that fluid may be injected through both the first group 26 of injection apertures 24 at the first injection rate and the second group 28 of injection apertures 24 at the second injection rate, to thereby define a third injection rate. The third injection rate being the combined sum of the first injection rate and the second injection rate.

The fluid injector 20 may be controlled to provide variable fluid injection spray patterns as well. Referring to FIG. 2, the first injection aperture 24A injects fluid from a first location on the injector tip 22, thereby defining a first spray pattern, and the second injection aperture 24B injects fluid from a second location on the injector tip 22, thereby defining a second spray pattern. It should further be appreciated that the size and/or shape of the first injection aperture 24A and the second injection aperture 24B may vary from each other, thereby further contributing to the differences between the first spray pattern and the second spray pattern.

Referring to FIG. 2, the first control device 34A may be controlled to allow fluid flow through the first injection aperture 24A, and the second control device 34B may be simultaneously controlled to prevent fluid flow through the second injection aperture 24B, such that fluid may be injected through only the first injection aperture 24A in the first spray pattern. Alternatively, the first control device 34A may be controlled to prevent fluid flow through the first injection aperture 24A, and the second control device 34B may be simultaneously controlled to allow fluid flow through the second injection aperture 24B, such that fluid may be injected through only the second injection aperture 24B in the second spray pattern. In yet another possibility, the first control device 34A may be controlled to allow fluid flow through the first injection aperture 24A and the second control device 34B may be simultaneously controlled to allow fluid flow through the second injection aperture 24B, such that fluid may be injected through both the first injection aperture 24A and the second injection aperture 24B in a third spray pattern, which is formed by the combination of the first spray pattern and the second spray pattern.

Referring to the exemplary embodiment of the injector tip 22 shown in FIG. 3, the same principle may be applied, because the first group 26 of injection apertures 24 will inject fluid with the first injection spray pattern, and the second group 28 of injection apertures 24 will inject fluid with the second injection spray pattern. Referring to FIG. 3 the first group 26 of injection apertures 24 may be controlled by their respective control devices 34 to allow fluid flow through each of the first group 26 of injection apertures 24, and the second group 28 of injection apertures 24 may be simultaneously controlled by their respective control devices 34 to prevent fluid flow through each of the second group 28 of injection apertures 24, such that fluid may be injected through only the first group 26 of injection apertures 24 with the first spray pattern. Alternatively, the first group 26 of injection apertures 24 may be controlled by their respective control devices 34 to prevent fluid flow through each of the first group 26 of injection apertures 24, and the second group 28 of injection apertures 24 may be simultaneously controlled by their respective control devices 34 to allow fluid flow through each of the second group 28 of injection apertures 24, such that fluid may be injected through only the second group 28 of injection apertures 24 with the second injection spray pattern. In yet another possibility, the first group 26 of injection apertures 24 may be controlled by their respective control devices 34 to allow fluid flow through each of the first group 26 of injection apertures 24, and the second group 28 of injection apertures 24 may be simultaneously controlled by their respective control devices 34 to also allow fluid flow through each of the second group 28 of injection apertures 24, such that fluid may be injected through both the first group 26 of injection apertures 24 with the first injection spray pattern and the second group 28 of injection apertures 24 with the second injection spray pattern, to thereby define a third injection spray pattern, which is formed by the combination of the first spray pattern and the second spray pattern.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A fluid injector comprising:
an injector tip defining a plurality of injection apertures;
a first control device coupled to the injector tip and operable to control fluid flow through at least a first one of the plurality of injection apertures; and
a second control device coupled to the injector tip and operable to control fluid flow through at least a second one of the plurality of injection apertures;
wherein the first control device and the second control device are independently operable relative to each other, such that one of the first one of the plurality of injection apertures and the second one of the plurality of injection apertures may be opened to allow fluid flow therethrough, while the other of the first one of the plurality of injection apertures and the second one of the plurality of injection apertures may be simultaneously closed to prevent fluid flow therethrough.

2. The fluid injector set forth in claim 1 wherein each of the first control device and the second control device includes one of either a Micro-Electrical-Mechanical System (MEMS) flow controller or a Nano-Electrical-Mechanical System (NEMS) flow controller.

3. The fluid injector set forth in claim 2 wherein the first one of the plurality of injection apertures defines a first injection area capable of injecting fluid at a first injection rate, and the second one of the plurality of injection apertures defines a second injection area capable of injecting fluid at a second injection rate that is different than the first injection rate.

4. The fluid injector set forth in claim 3 wherein the first control device may be controlled to allow fluid flow through the first one of the plurality of injection apertures and the second control device may be simultaneously controlled to prevent fluid flow through the second one of the plurality of injection apertures, such that fluid may be injected through only the first one of the plurality of injection apertures at the first injection rate.

5. The fluid injector set forth in claim 3 wherein the first control device may be controlled to prevent fluid flow through the first one of the plurality of injection apertures and the second control device may be simultaneously controlled to allow fluid flow through the second one of the plurality of injection apertures, such that fluid may be injected through only the second one of the plurality of injection apertures at the second injection rate.

6. The fluid injector set forth in claim 3 wherein the first control device may be controlled to allow fluid flow through the first one of the plurality of injection apertures and the second control device may be simultaneously controlled to allow fluid flow through the second one of the plurality of injection apertures, such that fluid may be injected through both the first one of the plurality of injection apertures and the second one of the plurality of injection apertures at a third injection rate.

7. The fluid injector set forth in claim 2 wherein the plurality of injection apertures includes a first group of injection apertures including the first one of the plurality of injection apertures, with the first control device controlling fluid flow through all of the injection apertures of the first group of injection apertures, and wherein the plurality of injection apertures includes a second group of injection apertures including the second one of the plurality of injection apertures, with the second control device controlling fluid flow through all of the injection apertures of the second group of injection apertures.

8. The fluid injector set forth in claim 7 wherein the first group of injection apertures are arranged to define a first aperture arrangement operable to inject fluid in a first spray pattern, and wherein the second group of injection apertures are arranged to define a second aperture arrangement operable to inject fluid in a second spray pattern that is different than the first spray pattern.

9. The fluid injector set forth in claim 8 wherein the first control device may be controlled to allow fluid flow through the first group of injection apertures and the second control device may be simultaneously controlled to prevent fluid flow through the second group of injection apertures, such that fluid may be injected through only the first group of injection apertures in the first spray pattern.

10. The fluid injector set forth in claim 8 wherein the first control device may be controlled to prevent fluid flow through the first group of injection apertures and the second control device may be simultaneously controlled to allow fluid flow through the second group of injection apertures, such that fluid may be injected through only the second group of injection apertures in the second spray pattern.

11. The fluid injector set forth in claim 8 wherein the first control device may be controlled to allow fluid flow through the first group of injection apertures and the second control device may be simultaneously controlled to allow fluid flow through the second group of injection apertures, such that fluid may be injected through both the first group of injection apertures and the second group of injection apertures in a third spray pattern.

12. The fluid injector set forth in claim 1 wherein each of the plurality of injection apertures includes a respective control device for controlling fluid flow through its respective injection aperture, such that each of the plurality of injection apertures may be controlled independently of all of the other of the plurality of injection apertures, and with each respective control device including one of either a Micro-Electrical-Mechanical System (MEMS) flow controller or a Nano-Electrical-Mechanical System (NEMS) flow controller.

13. The fluid injector set forth in claim 12 wherein each control device is attached to the injector tip adjacent its respective one of the plurality of injection apertures.

14. The fluid injector set forth in claim 13 wherein each control device is responsive to a respective control signal that is dedicated to only that respective control device, such that all respective control signals for all of the control devices are separate and independent from each other.

15. The fluid injector set forth in claim 1 wherein the first control device is attached to the injector tip adjacent the first one of the plurality of injection apertures, and the second control device is attached to the injector tip adjacent the second one of the plurality of injection apertures.

16. A liquid fuel injector for a vehicle having an internal combustion engine, the liquid fuel injector comprising:
an injector tip defining a first group of injection apertures and a second group of injection apertures;
a first control device coupled to the injector tip and operable to control fluid flow through the first group of injection apertures;
a second control device coupled to the injector tip and operable to control fluid flow through the second group of injection apertures;
wherein each of the first control device and the second control device includes one of either a Micro-Electrical-Mechanical System (MEMS) flow controller or a Nano-Electrical-Mechanical System (NEMS) flow controller; and
wherein the first control device and the second control device are independently operable relative to each other to selectively control fluid flow through each of the first group of injection apertures and the second group of injection apertures, such that one of the first group of injection apertures and the second group of injection apertures may be opened to allow fluid flow therethrough, while the other of the first group of injection apertures and the second group of injection apertures may be closed to prevent fluid flow therethrough.

17. The liquid fuel injector set forth in claim 16 wherein the first group of injection apertures includes a plurality of injection apertures, with each injection aperture of the first group of injection apertures defining a first injection area capable of injecting liquid fuel at a first injection rate, and the second group of injection apertures includes a plurality of injection apertures, with each injection aperture of the second group of injection apertures defining a second injection area capable of injecting liquid fuel at a second injection rate.

18. The liquid fuel injector set forth in claim 17 wherein the first injection area is different than the second injection area.

19. The liquid fuel injector set forth in claim 16 wherein the first group of injection apertures includes a plurality of injection apertures, with each injection aperture of the first group of injection apertures arranged to define a first aperture arrangement operable to inject liquid fuel in a first spray pattern, and the second group of injection apertures includes a plurality of injection apertures, with each injection aperture of the second group of injection apertures arranged to define a second aperture arrangement operable to inject liquid fuel in a second spray pattern.

20. The liquid fuel injector set forth in claim 19 wherein the first spray pattern is different than the second spray pattern.
